(19) United States
(12) Patent Application Publication
(10) Pub. No.: US 2010/0133045 A1
(43) Pub. Date: Jun. 3, 2010

(54) MOTORIZED STAIR LIFT

(76) Inventor: Aadrea Turina, Arlate Calco (IT)

Correspondence Address: Lonnie R Drayer, 6504 Cathedral Oaks Drive, Plant City, FL, 33565, US

(21) Appl. No.: 12/598,215

(22) PCT Filed: Apr. 30, 2008
(86) PCT No.: PCT/IB08/01081

§ 371 Date: Jan. 31, 2010

(30) Foreign Application Priority Data
May 2, 2007 (EP) 07425260.2

(51) Int. Cl. B66B 9/08

(52) U.S. Cl. 187/201

(57) ABSTRACT

A motorized stair-lift trolley (1) comprises a sling (4) for the attachment of the load to the trolley, comprising at least one pair of idler stabilizer-wheels (4a) located in a first housing (3) mounted rotatable with respect to the sling to adapt to the inclination of the rail and a means (90) of locking the first housing onto the sling; as well as a second housing (10) that houses the means (11) of moving the trolley and that is forced to rotate with respect to the sling to the same angle to which the first housing is rotated.

### FIELD OF THE INVENTION

The present invention relates to a motorized trolley for stair-lifts, cantilever-mounted on a rail and moving with respect to this. In particular, the motorized trolley in object is used in stair-lifts, i.e. devices for transporting people who are unable to go up or down stairs. Such devices comprise a trolley on which a footrest, mobile platform or seat is fitted, connected to the trolley by a sling, and allow one or more flights of stairs to be traversed comfortably and rapidly.

### TECHNICAL BACK GROUND

Stair-lift trolleys have to be able to follow long rails that comprise different inclinations or that have small turning radii, for instance, in the case where the rail turns the corner made by the walls that support two adjoining flights of stairs. EP0725034, in the name of the Applicant, describes a stair-lift trolley that comprises at least two pairs of idler stabilizer wheels opposed with respect to the two driven or traction wheels, that roll along the rail. The trolley furthermore comprises means of regulating the position of the two pairs of stabilizer-wheels in the direction parallel to the rail, in such a way as to modify the reciprocal position of the two pairs of stabilizer-wheels once the inclination of the rail is known.

The solution described above has, however, the drawback that the calibration of the two pairs of stabilizer-wheels of the trolley has a tolerance of around 10° of the variation of inclination of the rail and therefore they require to be calibrated whenever the trolley is installed on a different rail.

There are also known stair-lifts fitted to two rails fixed to the wall.

WO9529867, for instance, describes a motorized stair-lift trolley that comprises two motorized units in series, each fitted with a stabilizer-roller opposed to a traction roller and bound to a circular-section rail. As the inclination of the rail along the staircase varies, a motorized device, controlled by an angle-sensor and working between the trolley and the footplate, continually adjusts the position of the latter during the phases of ascent and descent along the rail, maintaining it in a horizontal position.

The solution mentioned above is rather complicated from a mechanical point of view since the two motorized units are connected by an articulated joint and are each endowed with at least one traction roller and at least one stabilizer-roller. Furthermore, the motorized trolley described in WO9529867 requires two separate rails to operate correctly; such rails need to be positioned with extreme care with respect to each the other when being attached to the wall since a small difference in alignment or parallelism between the two rails could jeopardize the normal movement of the trolley.

One purpose of the present invention is to provide a motorized trolley that allows the drawbacks indicated above to be overcome in a simple and safe way resulting in a motorized trolley that can be adapted to the rail in the assembly phase without the necessity of a previous manual adjustment of the stabilizer-wheels with respect to the same rail, even in the case of rails that involve steep inclination or small turning radii.

### SUMMARY OF THE INVENTION

These and other purposes are achieved by the present motorized trolley of the type cantilever-mounted on a rail and having at least one sling for attaching the load to the trolley, comprising at least one pair of stabilizer-wheels that roll on one side of the said rail and a means of moving the trolley bound to said sling and opposed to said at least one pair of stabilizer-wheels. Advantageously, the trolley comprises a first housing for said at least one pair of stabilizer-wheels, whose inclination during the assembly phase is adapted to the inclination of the rail, the housing being rotatable with respect to the said sling.

The trolley is provided with means of maintaining the vertical sling position acquired in the assembly phase. Such means are chosen from among: means of varying the position of the sling with respect to the said first housing and means of locking the sling in position.

For the purpose of the present invention, the term “sling” means any element to which the remaining part of the stair-lift, that comprises the support for the user is fixed. Therefore, in place of a sling, one or more plates or analogous means of attachment can be used.

According to an aspect of the invention, the trolley comprises a second housing for said means of movement that is mobile with respect to said first housing and rotatable with respect to the said sling as the inclination of said rail varies.

In practice, therefore, in the case of a rail with constant inclination, once the first housing is positioned with respect to the rail, the trolley moves along the same, transporting with it the base or seat bound integrally to the sling, without the latter oscillating during its ascent or descent. This is made possible by the first housing and the sling being reciprocally locked in the angular position reached in the assembly phase. The locking between the sling and the first housing is achieved by the employment of such locking elements as, for instance, screws.

In the case in which the said rail has at least one change of inclination, the trolley comprises means of varying the position of the first housing with respect to the sling in a controlled way, in such a way as to permit the trolley to be able to move along the rail and to maintain the vertical position of the sling. Then, when the trolley meets a variation of the inclination during the ascent or the descent along the rail, said means of variation of the inclination located between the first housing and the sling, force the first housing to rotate relative to the sling around a first pivot, so as to adapt to the inclination of the rail. As a consequence of such rotation the first housing drags the second housing into rotation; the second housing in its turn moves with respect to the first housing around a second pivot, until it reaches a position of equilibrium that is maintained during the ascent or the descent. The second housing is hinged on the sling and, for the purpose of guaranteeing the movements of rotation and translation of the second housing with respect to the first housing, the second pivot is mobile along a slot in the sling, thus ensuring the attainment of the equilibrium position of the trolley without oscillations of the footplate, wheelchair base or platform.

It should be noticed that in the case of a rail having constant inclination as described above, the second housing also rotates and moves with respect to the first housing until the trolley reaches an equilibrium position, but this occurs only in the phase of assembling the trolley onto the rail. Subsequently, the first housing is permanently locked in such a way as to maintain the sling at the same angle to the rail, and such position is maintained for the entire period of operation of the trolley.

However, in the case of a rail with varying inclination, the said means of variation comprise, for instance, an actuator and a position-sensor that checks and regulates the operation of the actuator on the basis of the position of the sling. In fact, depending on the position of the load with respect to the sling, a moment is produced on the sling that tends to unbalance it towards a different position from that initially assumed in the assembly phase. The actuator, therefore, on the basis of information transmitted by the position sensor, acts on the sling to return it to its initial position.

According to a preferred aspect of the invention, the means of moving the motorized trolley comprises at least one traction wheel. Preferably, the traction wheels are two in number, superimposed and co-axial. In this way the motorized trolley is also able to move on rails that present particularly short radii of curvature; in fact, contact between the traction wheel and the rail occurs only along one of the generators of the traction wheel or wheels, rather than, as in the case of the motorized trolleys known to the art cited above, occurring on two distinct generators located on two traction wheels with parallels axes of rotation. In these trolleys the position of the two traction wheels must be calibrated before the installation of the trolley on the rail when this presents a different radius of curvature.

The trolley according to the invention comprises two idler stabilizer-wheels and one traction wheel preferably composed of a plurality of co-axial rollers and located in a position intermediate between the axes of the two stabilizer-wheels. In practice, from a top view of the trolley, the lines joining the centers of the three wheels (the two stabilizer and the one traction) describe a triangle, preferably isosceles, allowing the trolley to round short radius of curvature without geometrically binding the position of the stabilizer-wheels to that of the traction wheel.

The rollers of the traction wheel comprise a layer in an elastically deformable type of material (for instance, rubber or other similar elastomer) in such a way as to permit the trolley to maintain a high degree of adherence along rails that present curves of different radius of curvature. In fact, in such case, while maintaining the separation between the pair of stabilizer-wheels and the traction wheel constant, the trolley it is still able to move along the rail due to the level of compression of the elastic element interposed between the rail and the traction wheel being sufficiently variable to compensate for the different shape of the rail along the curve.

### BRIEF DESCRIPTION OF DRAWINGS

A particular embodiment of the present invention is now described by way of example but not of limitation, with reference to the attached drawings in which:

FIG. 1 is a view in longitudinal section of the motorized trolley according to the invention;

FIG. 2 is a view in transverse section of the motorized trolley of FIG. 1;

FIG. 3 is a front view of the motorized trolley endowed with means of varying the position of the sling with respect to the first housing;

FIG. 4 is a side view of the motorized trolley mounted on a rail located to the left of a flight of stairs.

FIG. 5 is a front view of the motorized trolley mounted on a rail located to the right of a flight of stairs;

FIG. 6 is a perspective view of the motorized trolley according to the invention, not yet mounted on the rail.

### DETAILED DESCRIPTION OF A PARTICULAR EMBODIMENT OF THE INVENTION

With particular reference to such figures, the generic motorized trolley according to the invention is indicated by 1.

The trolley 1 comprises an external cover 2 that partly encloses a structure that comprises a sling 4, substantially parallelepiped in shape, employed for the attachment of the means of support of the load, for instance a base or a seat (not shown here), that must be moved along the rail or rails 8. On the sling 4 is bound a first housing 3 for a pair of idler stabilizer-wheels 4a that roll on the side 6 of the rail 8. The trolley 1 comprises a second housing 10 to which are bound means 11 of moving the trolley 1 along the rail 8 from the side 7 of the same; the means 11 being opposite to the pair of idler stabilizer wheels 4a.

In the embodiment shown, the means 11 comprise a traction wheel 70, subdivided into two rollers 12 and 13, a motor 14, a reduction gear 15 and electrical connections 60 extending along a corresponding track on the side 6 of the rail 8 for the power supply. As discussed above, the rollers that constitute the traction wheel 70 can also be one, two or more than two in number; preferably the traction rollers (or wheels) are co-axial and superimposed, but in an alternative embodiment (not shown here) there are at least two traction wheels 70 and they are so located as to have two separate parallel axes of rotation, however still serving the function of moving the trolley 1 along the rail 8.

In the particular embodiment of the invention described here, the two traction rollers 12 and 13 are mounted superimposed and co-axial one with respect to the other and they act only on the side 6 of the rail 8 along a generator that is longitudinally extended to the two rollers 12 and 13. Nevertheless, the traction rollers 12 and 13 may also be located separated without jeopardizing however the correct operation of the trolley 1.

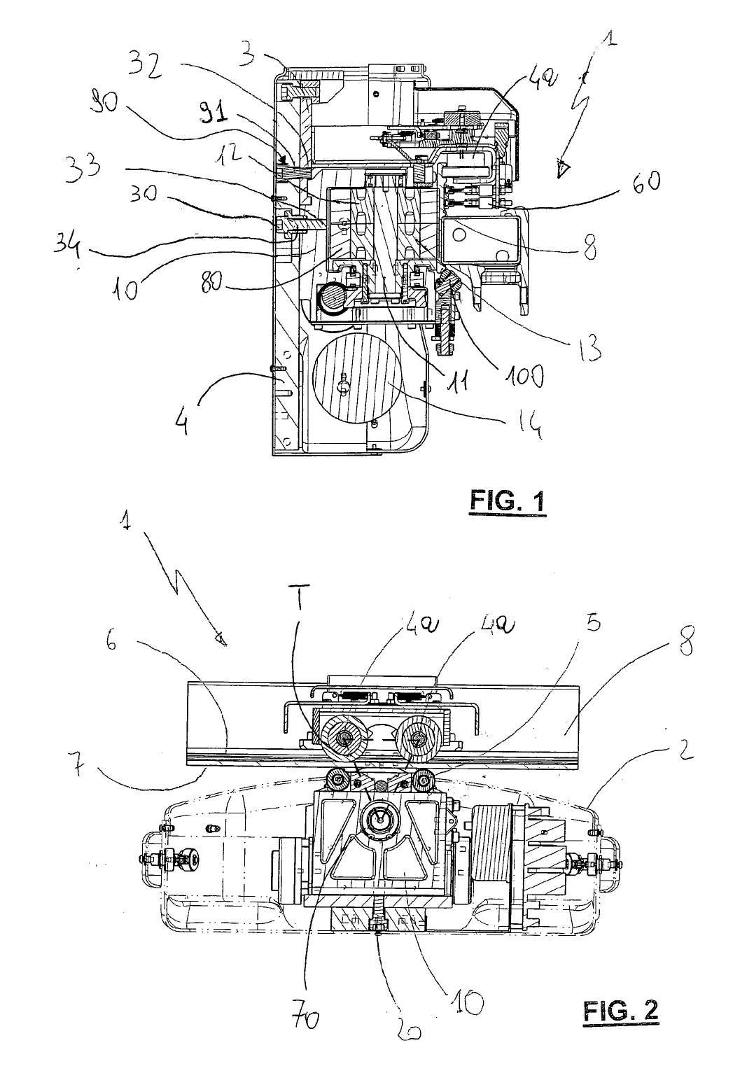

The two wheels of the pair of stabilizer-wheels 4a have their respective axis of rotation parallel to that of the traction wheel 70 as is furthermore evident from the FIGS. 1 and 2.

With the purpose of facilitating the movement of the trolley 1 along the rail 8 and avoiding possible overturns of the same in consequence of excessive loads acting on the sling 4, the first housing 3 can introduce a further pair of idler stabilizer wheels 5 opposed to the pair of wheels 4a and rolling on the side 7 of the rail 8.

According to an embodiment of the invention, the first housing 3 for the said pair of stabilizer-wheels 4a is rotatable with respect to the sling 4 around a first pivot 20, in such way that the pair of wheels 4a can adapt to the inclination of the rail 8 when mounted on this. In fact, in such circumstances the first housing 3 is rotated around the pivot 20 until it reaches the same inclination as the rail 8. In consequence of the rotation of the first housing 3, the second housing 10 rotates around a second pivot 30 and moves with respect to the first housing 3 along a linear rail 35. The translation and the rotation of the second housing 10 with respect to the sling 4 and to the first housing 3, are favored by the fact that the second pivot 30 is vertically aligned to the first pivot 20 and it is mobile inside a slot 31 on the sling 4. The pivots 20 and 30 respectively operate in two holes 32 and 33 found on the housings 3 and 10 and the hole 34 and the slot 31 present on the sling 4.

According to the invention, the trolley 1 is provided with means 90 of maintaining the mutual position between first housing 3, second housing 10 and sling 4. Such means 90 are chosen from among means of permanent locking 91 and means of variable locking 50.

In the case in which the rail has a constant inclination, the first housing 3 is locked onto the sling 4 in the same angular position reached in the phase of assembly onto the rail. The lock between the sling 4 and the first housing 3 is achieved by the employment of a known means of permanent locking 91 that comprises a fastening element, for instance, of the screw type (FIG. 1) working on the hole 32 and that creates a linkage between sling 4 and first housing 3 so strong as to prevent any relative movement. In this case the pivot 20 is replaced by the screw 91, which is tightened only at the end of the assembly phase of the trolley 1 onto the rail 8.

In practice therefore, in the case of a rail 8 having a constant inclination, once the first housing 3 has been positioned and locked with respect to the rail 8, the trolley 1 moves long the same rail transporting with itself the base bound integrally to the sling 4 without the latter oscillating during its ascent or descent, thus maintaining it in a horizontal position from the beginning to the end of the travel of the trolley 1.

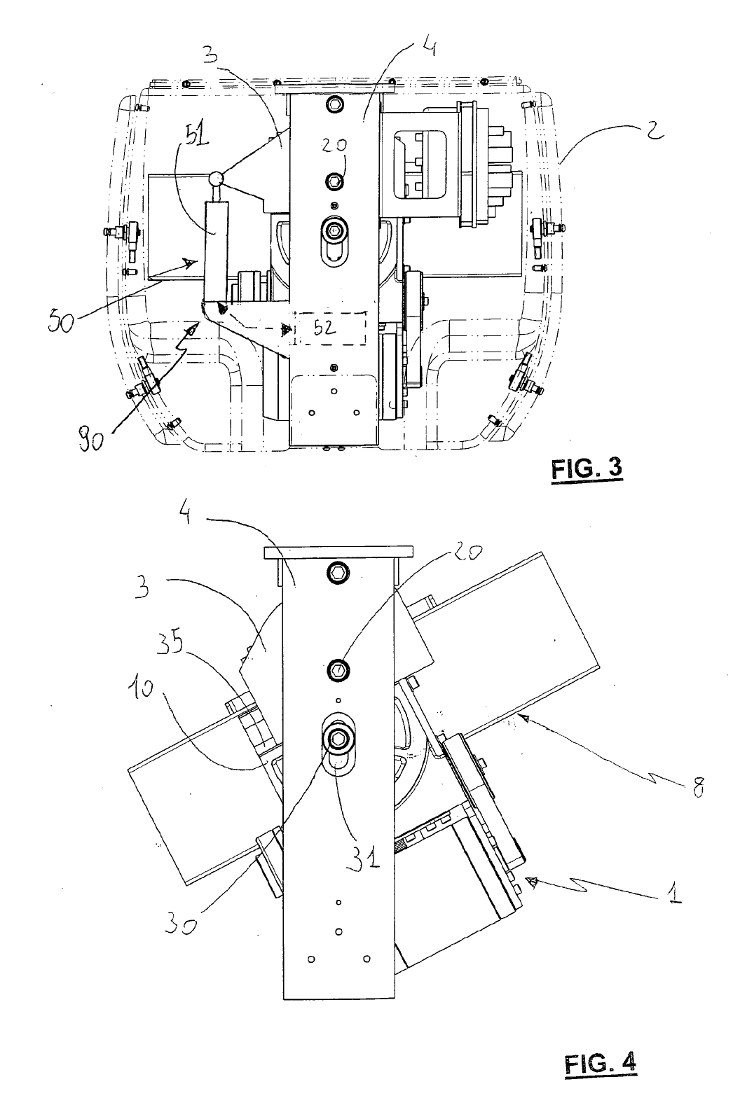

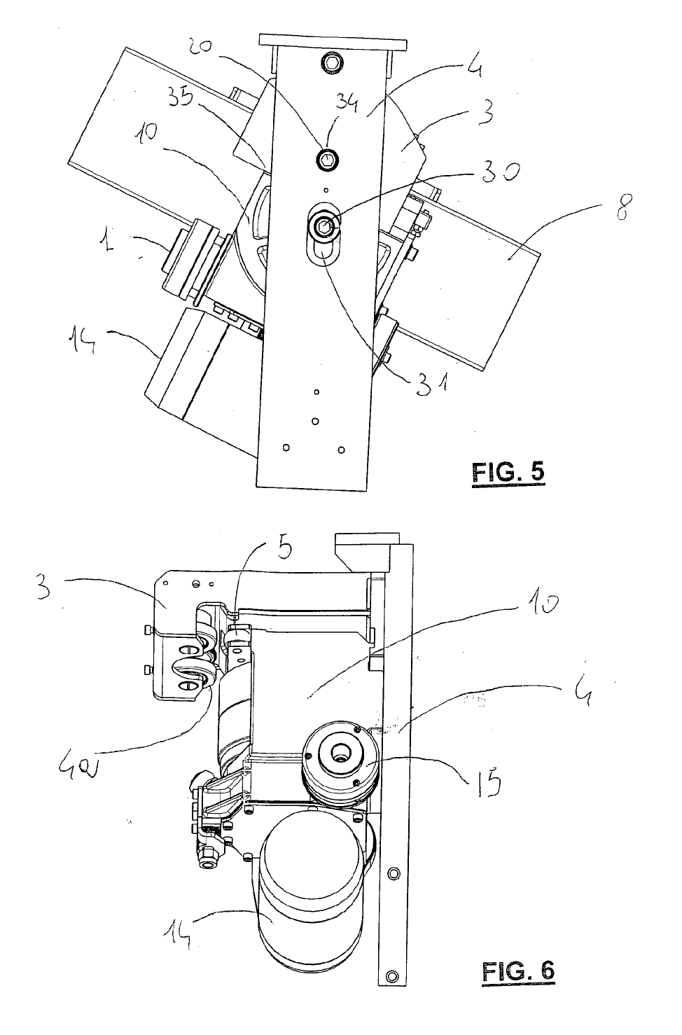

In the case in which the said rail 8 presents at least one change of inclination, the trolley 1 comprises means of variable locking 50 to vary in a controlled way the inclination of the said first housing 3 with respect to the said sling 4 (FIG. 3), in such a way as to permit the trolley 1 to be able to move along the rail while maintaining the sling in a vertical position. Therefore, when the trolley 1 meets a variation in the inclination during the ascent or the descent along the rail 8, said means 50 of varying the inclination, located between the first housing 3 and the sling 8, forces the first housing 3 to rotate relative to the sling 4 around the first pivot 20, dragging the second housing 3 in rotation around the second pivot 30. The second housing 10, in turn, during its rotation around the second pivot 30, moves with respect to the first housing 3 along the linear rail 35, until it reaches a position of stable equilibrium that is maintained during the entire ascent or the descent of the trolley 1 along the rail 8. Such position of stable equilibrium is reached the moment in which the common axis of the two traction rollers 12 and 13 is found to be parallel to the axes of the two stabilizer-wheels 4a. This results furthermore evident from the FIGS. 3, 4 and 5, in which the adjustment of the position of the two housings 3 and 10 is shown during the movement of the trolley along the rail 8, allowing the two pairs of wheels 4a and 5 and the traction wheel 70 to maintain their own axes of rotation parallel to each other in any condition of motion, be this horizontal (FIG. 3) or tilted (FIGS. 4 and 5). For simplicity, the said means 50 of varying the inclination of the first housing 3 with respect to the sling 4 has not been shown in FIGS. 4 and 5.

The attainment of the position of equilibrium occurs in a gradual way as a result of the employment of said means 50 of varying the position which allows the related angle between the first housing 3 and the said sling 4 to vary when the trolley 1 meets a variation of inclination along the rail 8. Said means 50 of variation comprises an actuator 51 and an inclination-sensor 52 (FIG. 3) that commands the actuator to move the first housing 3 with respect to the sling 4. Such inclination-sensor checks and regulates the operation of the actuator on the basis of the position of the sling. In fact, depending on the position of the load with respect to the sling, a moment is produced on the sling that has the tendency to unbalance it towards a position different from that initially assumed in the assembly phase. The actuator, therefore, on the basis of information transmitted by the position sensor, acts on the sling to return it to its initial position. In this case, the pivots 20 and 30 are equipped with suitable bearings (not shown here) able to support and to adequately distribute the load that acts on them.

What is described above allows more advantageously the alignment of the trolley 1 with the rail 8, whatever the inclination or the turning radius of the latter, to maintain the sling vertical to the ground and thus prevent possible and sudden oscillations of the footplate or wheelchair or platform anchored to the sling 4. Subsequently, according to the preferred embodiment of the invention, the said trolley 1 comprises at least one further stabilizer-wheel 100 bound to said second housing 10, and located between the two pairs of idler stabilizer wheels 4a and 5. In such way the trolley 1 assumes a more stable and secure configuration during its operation along the rail 8.

According to a further aspect of the invention the said means 11 of moving the motorized trolley comprises a traction wheel 70 composed of a plurality of rollers that share the same axis of rotation, a reduction gear unit 15, a motor 14 and electrical connections to supply power to said motor.

According to a particular aspect of the invention, the traction wheel 70 comprises two superimposed and co-axial rollers 12 and 13. In this way the motorized trolley 1 is also able to follow rails 8 that present particularly short radius of curvature. In fact the contact between the traction wheel and the rail occurs only along one of the generators of the wheel 70, rather than, as in the case of the motorized trolleys of the known art described more fully above, occurring on two generators located on two traction wheels with parallel axes of rotation. In these trolleys, the position of the two traction wheels must be calibrated before the installation of the trolley on a specific rail that presents a different radius of curvature. The dimensions themselves of the two traction wheels must be modified to overcome the problem of rails with reduced radius of curvature.

The motorized trolley 1 according to the invention comprises instead two idler stabilizer-wheels 4a and a traction wheel 70 located in intermediate position between the axes of the two stabilizer-wheels (FIG. 2), i.e. the projection of the axis of the traction wheel 70 is in the same vertical plane defined by the axes of the two stabilizer-wheels remaining contained inside the region defined by the same two axes of the two stabilizer-wheels 4a. In practice, from a view from above the trolley 1, the lines joining the centers of the three wheels, two stabilizer 4a and one traction 70, describe a triangle T preferably isosceles that ensures trolley 1 greater kinematic freedom. In fact, furthermore, besides allowing the trolley 1 to round short radii of curvature, it avoids the necessity of tying the dimension of the traction wheel 70 to the geometry of the rail 8 or to the position of the stabilizer-wheels 4a.

The trolley 1 so designed allows any type of rail 8 to be adapted to, and it is adaptable furthermore, to rails 8 located either to the right and to the left of the flight or of the flights of the stairs to be climbed.

It should be noticed that the rollers 12 and 13 of the traction wheel 70 may not superimposed, but may on the contrary be separated by some distance, without for this reason jeopardizing the correct operation of the trolley 1.

Furthermore, the two rollers 12 and 13 of the traction wheel 70 are faced with a layer 80 in elastically deformable material, of the rubber or other elastomero type, for instance, in such a way as to allow the trolley 1 to also maintain a high degree of adherence along the rail 8 in the case in which this presents curves having different radius of curvature. In fact, in this case the motive force exerted by the traction wheel 70 varies, since the position of the points of support of the two stabilizer-wheels 4a on the rail 8 varies. In such cases, also maintaining constant the wheelbase between the pair of stabilizer-wheels 4a and the traction wheel 70, the trolley 1 is still able to move along the rail 8 due to the fact that the level of compression of the elastically deformable layer 80 intermediate between the rail and the traction wheel can vary to compensate for the different shape of the rail along the curve.

1. A motorized trolley stair-lift of the type cantilever-mounted on a rail and having at least one sling for the fixing of the load to the trolley, comprising at least one pair of idler stabilizer-wheels on one side of the said rail and a means of moving the trolley bound to said sling and opposed to said at least one pair of stabilizer-wheels, a first housing for said at least one pair of stabilizer-wheels, said housing being mounted rotatably with respect to said sling to adapt to the inclination of the rail; and a means of locking said first housing to said sling.

2. The motorized trolley according to claim 1, further comprising a second housing lodging said means of moving the trolley, said second housing being constrained to rotate with respect to the sling to the same angle to which said first housing is rotated and being translatable along a linear rail present on said first housing following rotation of the said first housing.

3. The motorized trolley according to claim 1 wherein said means of locking comprises a fastening element located between said first housing and said sling that prevents relative movement between said first housing and said sling.

4. The motorized trolley according to wherein said means of locking comprises means of varying the angle between said sling and said first housing according to variations in the inclination of said rail, said means being located between said first housing and said sling.

5. The motorized trolley according to claim 4, wherein said means of varying the angle comprises an actuator and at least one inclination sensor to command said actuator according to variations in inclination of said rail.

6. The motorized trolley according to claim 2 wherein said first housing and said second housing are rotatably bound to the sling at two respective vertically aligned pivots.

7. The motorized trolley according to claim 6, wherein the pivot for the rotation of said second housing is vertically translatable inside a slot on said sling.

8. The motorized trolley according to any claim 1 further comprising at least one second pair of stabilizer-wheels integral with said first housing, opposed to the said pair of idler stabilizer-wheels.

9. The motorized trolley according to claim 1 wherein said means of moving the trolley comprises a means of traction selected from the group consisting of one or more superimposed and co-axial rollers or wheels and at least two separate traction wheels with parallel axes of rotation.

10. A motorized trolley of the type cantilever-mounted on a rail and having at least one sling for fixing a load to the trolley, comprising at least one pair of stabilizer stabilizer-wheels on one side of the said rail and a means of moving the trolley bound to said sling and opposed to said at least one pair of idler stabilizer-wheels, said means of moving the trolley comprising a traction wheel comprising one or more rollers having the same axis of rotation, said axis maintaining itself parallel to the axes of rotation of the wheels of the said at least one pair of stabilizer-wheels during the operation of the trolley.

11. The motorized trolley (1) according to claim 10, comprising two rollers.

12. The motorized trolley according to claim 10 wherein said traction wheel is located in an intermediary position between the axes of the said two stabilizer-wheels.

13. The motorized trolley according to claim 10 wherein said one or more rollers is faced with an elastically deformable material.

14. (canceled)

15. A stair lift comprising at least one motorized trolley according to claim 1.
